(19) United States
(12) Patent Application Publication
(10) Pub. No.: US 2017/0277836 A1
(43) Pub. Date: Sep. 28, 2017

(54) Identifying Professional Incentive Goal Progress and Contacts for Achieving Goal

(71) Applicant: International Business Machines Corporation, Armonk, NY (US)

(72) Inventors: Russell G. Olsen, Flower Mound, TX (US); Marina V. Pascali, Dallas, TX (US)

(21) Appl. No.: 15/077,207

(22) Filed: Mar. 22, 2016

(51) Int. Cl. G06F 19/00

(52) U.S. Cl. CPC G06F 19/327; G06F 19/322

(57) ABSTRACT

Mechanisms are provided for assisting medical practitioners to achieve incentive goals. The mechanisms generate a patient registry comprising a plurality of patient registry records where each patient registry record is associated with a corresponding patient and comprises personal and medical information about the corresponding patient. The mechanisms evaluate a registry of incentive goals for a medical practitioner based on the patient registry to determine an incentive goal whose criteria the medical practitioner has not yet met. The mechanisms determine an action to be performed by one or more patients to meet the criteria of the incentive goal and analyze the patient registry to identify a set of patients to perform the action. The mechanisms then generate an output identifying the set of patients.

### BACKGROUND

The present application relates generally to an improved data processing apparatus and method and more specifically to mechanisms for identifying professional incentive goal progress and contacts for achieving the goal.

Various programs have been established for compensating medical personnel for treating patients based on the medical codes associated with their patient medical records. For example, under the United States Federal Health Insurance program referred to as Medicare, in accordance with section 5501(a) of the Affordable Care Act, a Primary Care Incentive Payment Program (PCIP) has been established for compensating medical personnel, or practitioners, with certain Medicare specialty designations if primary care services, corresponding to medical codes 99201-99215 and 99304-99350, accounted for at least 60 percent of the practitioner's total allowed charges under the physician fee schedule in a qualifying calendar year. Similar programs exist for various health care insurance and payment providers. These incentives are directed to encouraging practitioners to provide medical services to patients that benefit the patient by receiving medical services that will likely reduce or avoid more complex medical conditions in the future, benefit the practitioners monetarily, and benefit the health insurance provider or payor by reducing overall costs by spending insurance funds on preventative care in an attempt to avoid more costly health care for complex medical conditions.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method is provided, in a data processing system comprising at least one processor and at least one memory, for assisting medical practitioners to achieve incentive goals. The method comprises generating, by the data processing system, a patient registry comprising a plurality of patient registry records where each patient registry record is associated with a corresponding patient and comprises personal and medical information about the corresponding patient. The method further comprises evaluating, by the data processing system, a registry of incentive goals for a medical practitioner based on the patient registry to determine an incentive goal whose criteria the medical practitioner has not yet met. Moreover, the method comprises determining, by the data processing system, an action to be performed by one or more patients to meet the criteria of the incentive goal and analyzing, by the data processing system, the patient registry to identify a set of patients to perform the action. The method also comprises generating, by the data processing system, an output identifying the set of patients.

In other illustrative embodiments, a computer program product comprising a computer usable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is a block diagram illustrating a cloud computing system 100 for providing software as a service, where a server provides applications and stores data for multiple clients in databases according to one example embodiment of the invention;

FIG. 2 is another perspective of an illustrative cloud computing environment in which aspects of the illustrative embodiments may be implemented;

FIG. 3 is an example diagram illustrating a set of functional abstraction layers provided by a cloud computing environment in accordance with one illustrative embodiment;

FIG. 4 is an example block diagram illustrating the primary operational elements of a patient registry engine comprising incentive goal progress evaluation logic in accordance with one illustrative embodiment;

FIG. 5 is a flowchart outlining an example operation for identifying a practitioner's progress towards achieving an incentive goal in accordance with one illustrative embodiment; and

FIG. 6 is a flowchart outlining an example operation for performing operations to select patients to contact and initiate communications with the selected patients based on a progress of a practitioner towards an incentive goal in accordance with one illustrative embodiment.

### DETAILED DESCRIPTION

As noted above, many government and private organizations have established incentive programs for professionals, and in particular health care practitioners, in an effort to keep overall costs at a minimum. Many times, such incentive programs base the compensation provided to medical practitioners on aggregate goals over a plurality of patients. The example Medicare PCIP discussed above is one such program. As another example, under certain private health insurance programs, incentives are provided to medical practitioners if they can show that a certain percentage of patients classified with a certain medical malady have receives specified care within a specified time period, e.g., 80% of a practitioner's type 2 diabetes patients have had their annual foot exam. While this greatly incentivizes medical practitioners to expend resources to achieve the compensation goals, currently there are no adequate tools to assist the medical practitioner in determining their progress towards achieving these goals and identifying potential candidate patients that can assist the medical practitioner in achieving their goals.

The illustrative embodiments provide mechanisms for identifying the progress of medical personnel, a medical practice, or other provider of medical services (hereafter referred to collectively as a medical “practitioner”), towards an incentive goal established by a governmental or private organization's incentive program. Based on the determined progress, the mechanisms of the illustrative embodiments determine how the practitioner may achieve the incentive goal and identifies patients that are candidates for assisting the practitioner in achieving the incentive goal. Operations are then performed to initiate communications with the identified patients to solicit from them compliance actions/events that will advance the practitioner's progress towards the incentive goal. For example, if a practitioner is currently at 70% of their type 2 diabetes patients that have had their annual foot exam, and the practitioner needs to be at 80% to achieve an incentive goal, then the practitioner's other type 2 diabetes patients that have not come in for their annual foot exam may be automatically identified and communications sent to the corresponding patients encouraging them to come in for their annual foot examination.

Before beginning a more detailed discussion of the various aspects of the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on general purpose hardware, software instructions stored on a medium such that the instructions are readily executable by specialized or general purpose hardware, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

In the following description, reference is made to embodiments of the invention. However, it should be understood that the invention is not limited to specific described embodiments. Instead, any combination of the following features and elements, whether related to different embodiments or not, is contemplated to implement and practice the invention. Furthermore, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

In addition, it should be appreciated that the present description uses a plurality of various examples for various elements of the illustrative embodiments to further illustrate example implementations of the illustrative embodiments and to aid in the understanding of the mechanisms of the illustrative embodiments. These examples are intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

As noted above, incentive programs of various types, such as government sponsored programs, insurance company sponsored programs, and other private and public party organization based incentive programs, have been established for compensating medical practitioners for treating patients based on the medical codes associated with their patient medical records and corresponding goals established for these various programs. The illustrative embodiments provide mechanisms for assisting with the identification of patients that can help a practitioner achieve their incentive goals under these various programs, as well as in some cases pairing up patients with practitioners, which may or may not have been previous patients of the practitioner, to assist practitioners in achieving their goals for obtaining incentives under established incentive programs. In one illustrative embodiment, the mechanisms of the illustrative embodiments determine the practitioner's requirements based on their current status for achieving a particular incentive goal and the types of activities that are required to achieve that goal, e.g., if a goal is to have a particular number of patients (e.g., 80% of the practitioner's patients) come in and have a particular wellness test performed, and the practitioner's current status is below the requirement, the system determines how far the practitioner is away from the goal and what types of actions are required on the part of the practitioner/patients to achieve the goal, e.g., if the practitioner is currently at 70% patients getting their wellness check, then the practitioner must have 10% more of his patients come in to get the wellness check done, e.g., with 100 patients, another 10 patients would need to come in and get the wellness check done.

The mechanisms of the illustrative embodiments then analyze a patient registry for the practitioner and determine the most likely patients that will perform the required action if engaged. This targets the patients that are most likely to help achieve the incentive goal as determined from evaluation of the patients' characteristics as qualifying for the particular incentive goal, e.g., type 2 diabetic patient, the patient's previous historical responses to such engagements, as well as historical information specifically directed to the particular action required, e.g. getting a wellness check done. This evaluation may take into consideration historical information as to the responsiveness in general of patient's to such engagements such that more patients that are required to achieve the incentive goal may be communicated with knowing that not all of these patients will respond with a compliance action/event that will further the practitioner's progress towards the incentive goal, e.g., only 50% of the patients contacted in this way will actually respond with a compliance action/event (e.g., having their annual foot exam) and thus, twice as many patients may be contacted (e.g., in the case where there are 100 patients and 10% more is needed to achieve the incentive goal, 20 patients may be contacted instead of only 10).

Once identified, human initiated or automated communications may be sent to the identified patients to solicit the patients engaging in a compliance action/event. The compliance action/event may be one that causes a corresponding patient to become compliant with a treatment plan associated with a medical malady associated with the corresponding patient. Such communications may be based on a determination of the best mode of communications and/or sequence of modes of communication to be sent to the particular patient as described in commonly assigned and co-pending U.S. patent application Ser. No. 15/012,922 (Attorney Docket No. SVL920150141US1), entitled “Personalized Sequential Multi-Modal Patient Communication Based on Historical Analysis,” which is incorporated herein by reference. As described in this co-pending and commonly assigned patent document, the mode(s) of communication used to communicate with the patient may be based on the patient registry information indicating preferences of the patient, consents provided by the patient, historical analysis of the patient's responsiveness, or a group of patients having similar characteristics, e.g., a patient cohort, and other factors for determining the best mode(s) of communication for maximizing the likelihood of the patient performing a compliance action/event. Moreover, based on the selection of the mode(s) of communication to be used, automated mechanisms may automatically sent such communications, possibly in accordance with a determined sequencing of the communications, using pre-defined templates of scripts which are customized to the particular patient. The system may also monitor for a subsequent compliance action/event being performed by the patient.

Based on the determined mode of communication, the communication is sent to the patient and corresponding records are updated to indicate that the patient was contacted with regard to the particular incentive goal. This record keeping is used to facilitate managing repeated communications to the same patient regarding the same incentive goal, e.g., avoiding multiple communications of the same communication mode to the same patient regarding the same compliance action to achieve the same incentive goal. This record keeping may indicate the type of communication mode used, the timestamp associated with the communication, and any response from the patient that may have been received, among other information if desirable for the particular implementation.

The monitoring of the practitioner's advancement towards the incentive goal may be periodically or continuously monitored such that additional communications, such as additional communications in accordance with a determined sequence, may be sent to the same or additional patients. For example, if the practitioner's advancement to towards the incentive goal is still wanting after an initial operation to contact patients to assist with achieving the incentive goal, then a subsequent update to the patients that may be likely to assist the practitioner in achieving their incentive goal may be performed and the process above repeated. In updating the set of patients to be contacted, patients that responded to the previous communications by performing a compliance action/event will be naturally eliminated from the set of patients to be contacted. The monitoring may be performed periodically, for example, over a period of time of applicability of the various incentive goals, e.g., if the incentive goal is on an annual basis, then the monitoring may be performed periodically, or continuously, over the calendar year.

Patients that did not respond to the previous communications by performing a compliance action/event may be kept in the set of patients to be contacted or may be removed from the set, depending on the desired implementation. In some embodiments, where these non-responsive patients are maintained in the set of patients to be contacted, the set of patients may be expanded to include additional patients in the patient registry that meet the requirements for inclusion in the set of patients, but that were not previously selected for inclusion in the set of patients. In such embodiments, for those patients that are previous non-responsive patients, the communication mode for contacting these previous non-responsive patients may be updated to use a different communication mode than previously used.

It should be appreciated that this functionality for assisting the practitioner in achieving their incentive goals may be performed across many different incentive programs offered by the same or different organizations or programs. Thus, for example, a practitioner may be an approved provider of medical services for a plurality of different health insurance companies, each of which may have their own incentive programs established. The illustrative embodiments may monitor the practitioner's progress towards achieving each of these incentive programs and may identify patients that qualify for assisting the practitioner in achieving these various incentive program goals. This may require taking into account the organizations with which the patient is associated, e.g., which health insurance company the patient uses to pay for health services. Moreover, this may involve, in some illustrative embodiments, determining which incentive program goals the practitioner is closest to achieving and focusing the operation of the illustrative embodiments on those goals rather than all of the goals of the many different incentive programs of the many different organizations. For example, only those incentive goals that the practitioner is within a pre-defined range of the goal may be selected for use as a basis for performing the operations described herein, e.g., only the goals which the practitioner only needs 30% or less additional participation may be selected for use in performing the operations of the present invention.

In another illustrative embodiment, the mechanisms may be employed across a pool of practitioners and a pool of patients so that patients that need certain medical care can be paired with practitioners that need to provide that medical care to meet desired incentive goals. That is, in some illustrative embodiments, patients are directed to particular practitioners that need those patients based on the needs of that practitioner to achieve incentive goals regardless of whether that patient has been associated with the practitioner in the past or not. Thus, rather than limiting the analysis of patient information to identify candidate patients to contact for achieving incentive goals to the patients associated with the practitioner, the analysis is expanded to all patients of a particular pool, e.g., all patients within a geographic region of the practitioner and that meet the requirements of the incentive goal, regardless of whether they are actually associated with the practitioner or not. Various levels of granularity may be applied to define the pool of the patients considered for such analysis including, but not limited to, identify patients that are associated with a same network of medical practices, a same health insurance company or payment provider, employed by the same or affiliated employers, or the like. The main concept in these illustrative embodiments is that the analysis is not limited to only existing patients of the practitioner. However, preference may be provided to existing patients of the practitioner such that these existing patients may be selected first in a priority manner over other patients that are not existing patients when determining the set of patients to contact. In subsequent iterations, where the patients to contact may need to be expanded, additional priority preference may be provided to other patients that are not existing patients of the practitioner but have other desirable characteristics, such as geographical location of the patient relative to the practitioner, for example.

Thus, the mechanisms of the illustrative embodiments provide functionality for assisting a medical practitioner in achieving incentive goals established by an organization. These mechanisms determine the practitioner's progress towards the incentive goal as well as the actions that are required for the practitioner to achieve the incentive goal. Moreover, the mechanisms of the illustrative embodiments provide functionality for identifying patients that can assist the practitioner in achieving the incentive goal and contacting these patients to solicit a compliance action/event from the patients which will advance the practitioner's progress towards achieving the incentive goal. Such mechanisms may operate across a pool of practitioners and a pool of patients and may monitor multiple incentive goals provided by the same or a plurality of different incentive goal program providers.

From the above general overview of the mechanisms of the illustrative embodiments, it is clear that the illustrative embodiments are implemented in a computing system environment and thus, the present invention may be implemented as a data processing system, a method implemented in a data processing system, and/or a computer program product that, when executed by one or more processors of one or more computing devices, causes the processor(s) to perform operations as described herein with regard to one or more of the illustrative embodiments. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As shown in the figures, and described hereafter, one or more computing devices comprising a distributed data processing system, may be specifically configured to implement a personalized patient care plan system in accordance with one or more of the illustrative embodiments. The configuring of the computing device(s) may comprise the providing of application specific hardware, firmware, or the like to facilitate the performance of the operations and generation of the outputs described herein with regard to the illustrative embodiments. The configuring of the computing device(s) may also, or alternatively, comprise the providing of software applications stored in one or more storage devices and loaded into memory of a computing device for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of one or more of the illustrative embodiments and is not a general purpose computing device. Moreover, as described hereafter, the implementation of the mechanisms of the illustrative embodiments improves the functionality of the computing device(s) and provides a useful and concrete result that facilitates creation, monitoring, and adjusting personalized patient care plans based on personalized lifestyle information and assessment of patient adherence to the personalized patient care plan.

As mentioned above, the mechanisms of the illustrative embodiments may be implemented in many different types of data processing systems, both stand-alone and distributed. Some illustrative embodiments implement the mechanisms described herein in a cloud computing environment. It should be understood in advance that although a detailed description on cloud computing is included herein, implementation of the teachings recited herein are not limited to a cloud computing environment. Rather, embodiments of the present invention are capable of being implemented in conjunction with any other type of computing environment now known or later developed. For convenience, the Detailed Description includes the following definitions which have been derived from the “Draft NIST Working Definition of Cloud Computing” by Peter Mell and Tim Grance, dated Oct. 7, 2009.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models. Characteristics of a cloud model are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service models of a cloud model are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment models of a cloud model are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes. A node in a cloud computing network is a computing device, including, but not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. A cloud computing node is capable of being implemented and/or performing any of the functionality set forth hereinabove.

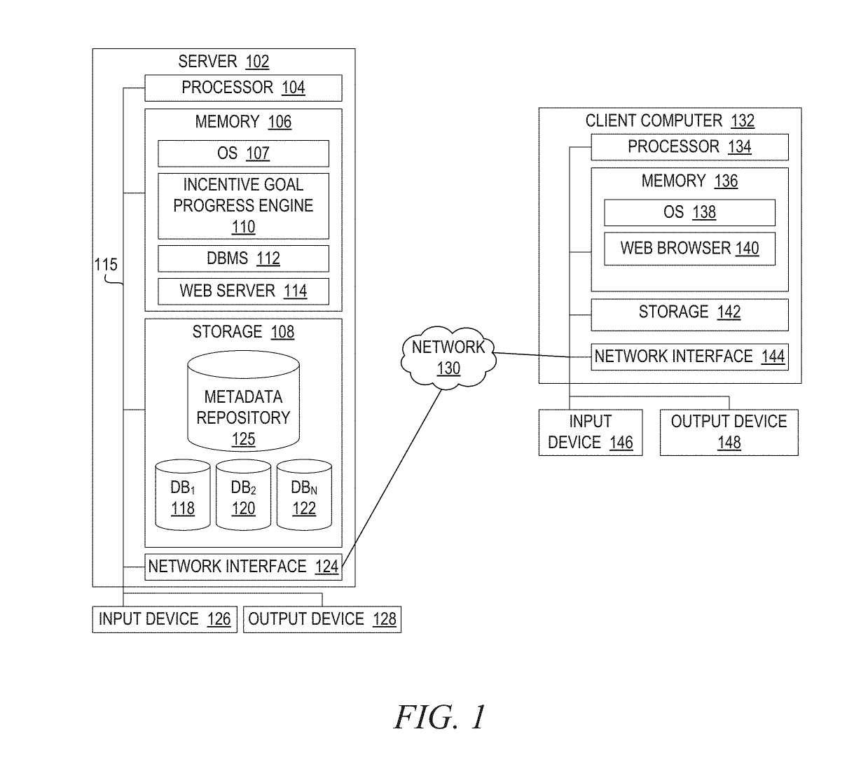

FIG. 1 is a block diagram illustrating a cloud computing system 100 for providing software as a service, where a server provides applications and stores data for multiple clients in databases according to one example embodiment of the invention. The networked system 100 includes a server 102 and a client computer 132. The server 102 and client 132 are connected to each other via a network 130, and may be connected to other computers via the network 130. In general, the network 130 may be a telecommunications network and/or a wide area network (WAN). In a particular embodiment, the network 130 is the Internet.

The server 102 generally includes a processor 104 connected via a bus 115 to a memory 106, a network interface device 124, a storage 108, an input device 126, and an output device 128. The server 102 is generally under the control of an operating system 107. Examples of operating systems include UNIX, versions of the Microsoft Windows™ operating system, and distributions of the Linux™ operating system. More generally, any operating system supporting the functions disclosed herein may be used. The processor 104 is included to be representative of a single CPU, multiple CPUs, a single CPU having multiple processing cores, and the like. Similarly, the memory 106 may be a random access memory. While the memory 106 is shown as a single identity, it should be understood that the memory 106 may comprise a plurality of modules, and that the memory 106 may exist at multiple levels, from high speed registers and caches to lower speed but larger DRAM chips. The network interface device 124 may be any type of network communications device allowing the server 102 to communicate with other computers via the network 130.

The storage 108 may be a persistent storage device. Although the storage 108 is shown as a single unit, the storage 108 may be a combination of fixed and/or removable storage devices, such as fixed disc drives, solid state drives, floppy disc drives, tape drives, removable memory cards or optical storage. The memory 106 and the storage 108 may be part of one virtual address space spanning multiple primary and secondary storage devices.

As shown, the storage 108 of the server contains a plurality of databases. In this particular drawing, four databases are shown, although any number of databases may be stored in the storage 108 of server 102. Storage 108 is shown as containing databases numbered 118, 120, and 122, each corresponding to different types of patient and/or medical practitioner related data, e.g., electronic medical records (EMRs), patient demographic information, patient communication history information, medical practitioner incentive program data, medical practitioner service histories indicating the different medical practitioner services provided within specified time periods, and any other patient and/or medical practitioner data that may be used to facilitate the operations of the illustrative embodiments with regard to identifying medical practitioner progress towards achieving incentive goals and identifying patients that can assist medical practitioners in achieving such incentive goals. Storage 108 is also shown containing metadata repository 125, which stores identification information, pointers, system policies, and any other relevant information that describes the data stored in the various databases and facilitates processing and accessing the databases.

The input device 126 may be any device for providing input to the server 102. For example, a keyboard and/or a mouse may be used. The output device 128 may be any device for providing output to a user of the server 102. For example, the output device 108 may be any conventional display screen or set of speakers. Although shown separately from the input device 126, the output device 128 and input device 126 may be combined. For example, a display screen with an integrated touch-screen may be used.

As shown, the memory 106 of the server 102 includes an incentive goal progress engine application 110 configured to provide a plurality of services to users, e.g., medical practitioners, incentive goal providers, or the like, via the network 130. As shown, the memory 106 of server 102 also contains a database management system (DBMS) 112 configured to manage a plurality of databases contained in the storage 108 of the server 102. The memory 106 of server 102 also contains a web server 114, which performs traditional web service functions, and may also provide application server functions (e.g. a J2EE application server) as runtime environments for different applications, such as the medical code re-coding engine application 110.

As shown, client computer 132 contains a processor 134, memory 136, operating system 138, storage 142, network interface 144, input device 146, and output device 148, according to an embodiment of the invention. The description and functionality of these components is the same as the equivalent components described in reference to server 102. As shown, the memory 136 of client computer 132 also contains web browser 140, which is used to access services provided by server 102 in some embodiments.

The particular description in FIG. 1 is for illustrative purposes only and it should be understood that the invention is not limited to specific described embodiments, and any combination is contemplated to implement and practice the invention. Although FIG. 1 depicts a single server 102, embodiments of the invention contemplate any number of servers for providing the services and functionality described herein. Furthermore, although depicted together in server 102 in FIG. 1, the services and functions of the incentive goal progress engine application 110 may be housed in separate physical servers, or separate virtual servers within the same server. The incentive goal progress engine application 110, in some embodiments, may be deployed in multiple instances in a computing cluster. The modules performing their respective functions for the incentive goal progress engine application 110 may be housed in the same server, on different servers, or any combination thereof. The items in storage, such as metadata repository 125, databases 118, 120, and 122, may also be stored in the same server, on different servers, or in any combination thereof, and may also reside on the same or different servers as the application modules.

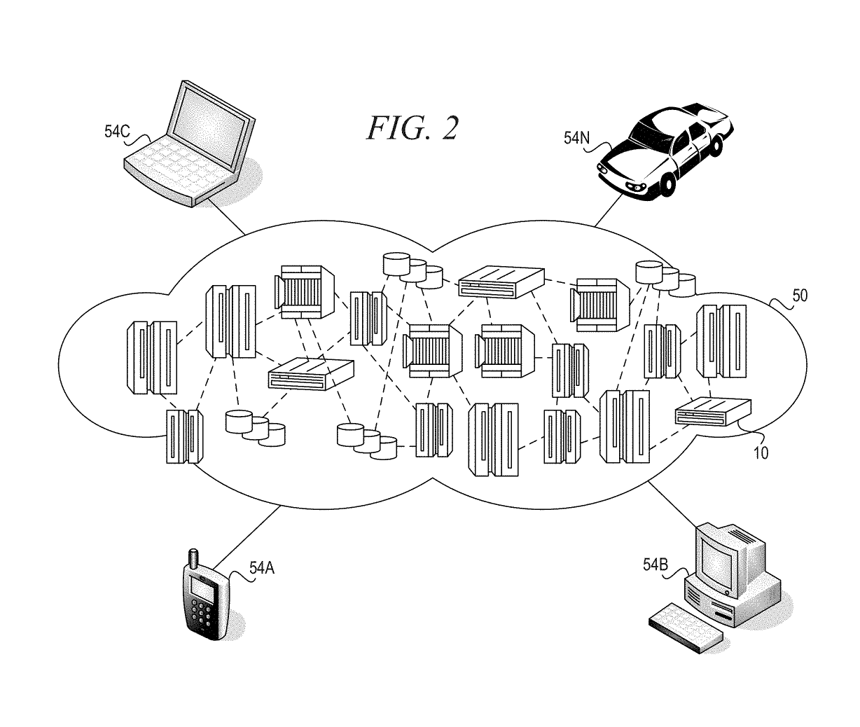

Referring now to FIG. 2, another perspective of an illustrative cloud computing environment 250 is depicted. As shown, cloud computing environment 250 comprises one or more cloud computing nodes 210, which may include servers such as server 102 in FIG. 1, with which local computing devices used by cloud consumers, such as, for example, personal digital assistant (PDA) or cellular telephone 254A, desktop computer 254B, laptop computer 254D, and/or automobile computer system 254N may communicate. Nodes 210 may communicate with one another. A computing node 210 may have the same attributes as server 102 and client computer 132, each of which may be computing nodes 210 in a cloud computing environment. They may be grouped (not shown) physically or virtually, in one or more networks, such as Private, Community, Public, or Hybrid clouds as described hereinabove, or a combination thereof. This allows cloud computing environment 250 to offer infrastructure, platforms and/or software as services for which a cloud consumer does not need to maintain resources on a local computing device. It is understood that the types of computing devices 254A-N shown in FIG. 2 are intended to be illustrative only and that computing nodes 210 and cloud computing environment 250 can communicate with any type of computerized device over any type of network and/or network addressable connection (e.g., using a web browser).

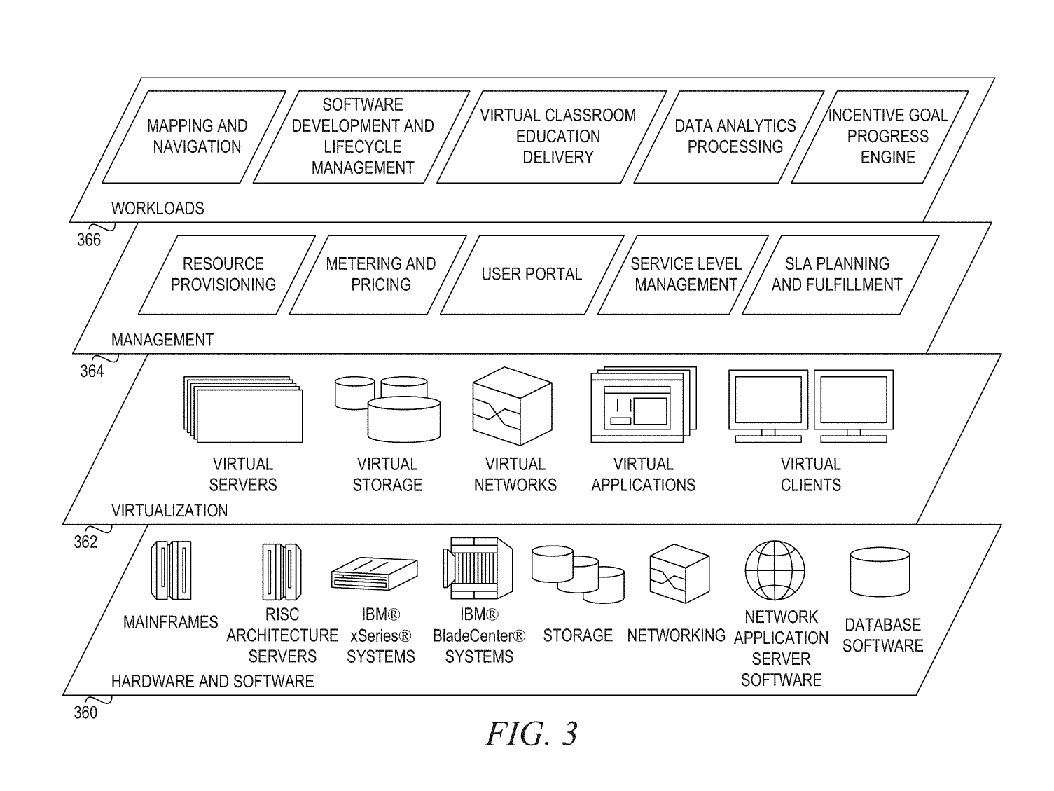

Referring now to FIG. 3, a set of functional abstraction layers provided by cloud computing environment 250 (FIG. 2) is shown. It should be understood in advance that the components, layers, and functions shown in FIG. 3 are intended to be illustrative only and embodiments of the invention are not limited thereto. As depicted, the following layers and corresponding functions are provided.

The hardware and software layer 360 includes hardware and software components. Examples of hardware components include mainframes, in one example IBM™ zSeries™ systems; RISC (Reduced Instruction Set Computer) architecture based servers, in one example IBM pSeries™ systems; IBM xSeries™ systems; IBM BladeCenter™ systems; storage devices; networks and networking components. Examples of software components include network application server software, in one example IBM WebSphere™ application server software; and database software, in one example IBM DB2™ database software. (IBM, zSeries, pSeries, xSeries, BladeCenter, WebSphere, and DB2 are trademarks of International Business Machines Corporation registered in many jurisdictions worldwide.).

The virtualization layer 362 provides an abstraction layer from which the following examples of virtual entities may be provided: virtual servers; virtual storage; virtual networks, including virtual private networks; virtual applications and operating systems; and virtual clients. In one example, management layer 364 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 366 provides examples of functionality for which the cloud computing environment may be utilized. Examples of workloads and functions which may be provided from this layer include: mapping and navigation; software development and lifecycle management; virtual classroom education delivery; data analytics processing; transaction processing; and, in accordance with the mechanisms of the illustrative embodiments, an incentive goal progress engine functionality.

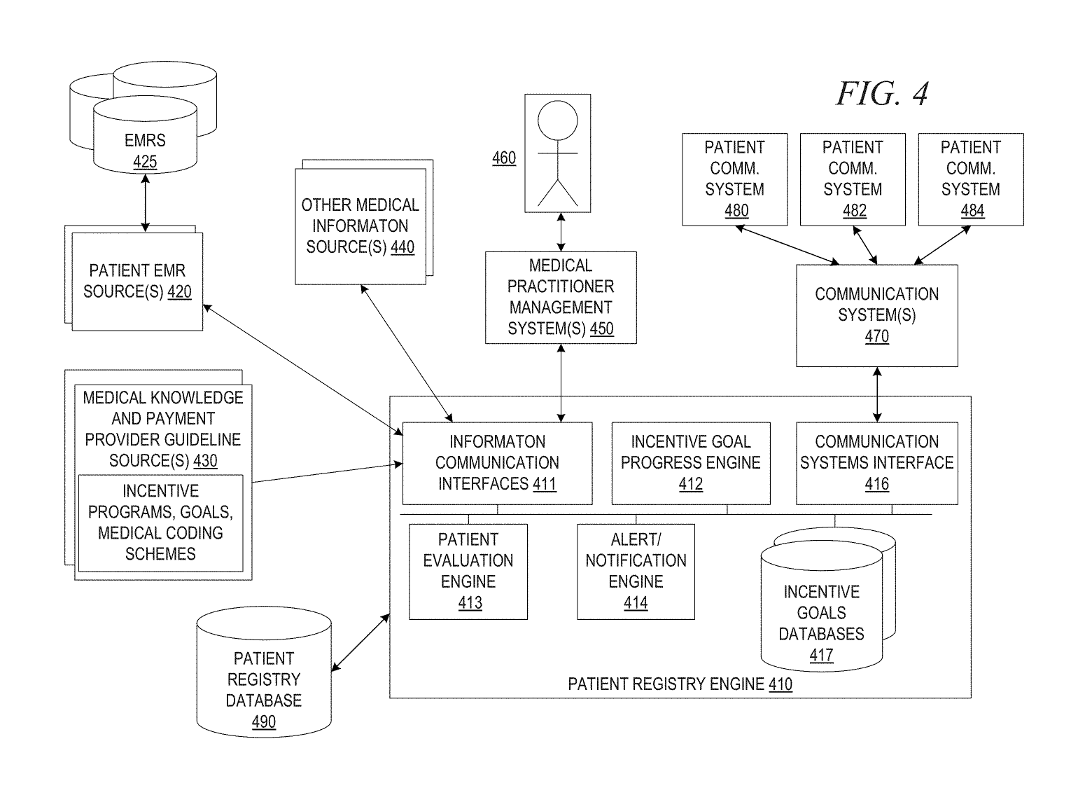

As discussed above, the illustrative embodiments provide an incentive goal progress engine which may be implemented in various types of data processing systems. FIG. 4 is an example block diagram illustrating the primary operational elements of such a patient registry engine having incentive goal progress tracking and evaluation logic in accordance with one illustrative embodiment. The operational elements shown in FIG. 4 may be implemented as specialized hardware elements, software executing on hardware elements, or any combination of specialized hardware elements and software executing on hardware elements without departing from the spirit and scope of the present invention.

As shown in FIG. 4, the primary operational elements comprise a patient registry engine 410, one or more patient electronic medical record (EMR) sources 420, one or more medical knowledge and payment provider guideline sources 430, other medical information source(s) 440, a medical practitioner management system 450 for communicating with a medical practitioner 460, one or more communication systems 470, and a patient registry database 490. It should be appreciated that while the elements 410-490 are illustrated as separate elements in FIG. 4, the illustrative embodiments are not limited to such. Rather, many of the elements shown in FIG. 4 may be integrated with one another without departing from the spirit and scope of the illustrative embodiments. For example, in some illustrative embodiments, the patient EMR sources 420, medical practitioner management systems 450, patient registry engine 410, communication systems 470, and patient registry database 490 may all be integrated with one another so as to provide a single suite of tools that may be executed or otherwise implemented using one or more data processing systems. This single suite of tools may be deployed at a single medical practice location and corresponding data processing systems, in a centralized or distributed fashion in association with multiple medical practices and locations, or any other suitable deployment configuration.

The patient registry engine 410 provides the various engines and logic for ingesting and processing patient electronic medical records (EMRs), medical knowledge and payment provider guidelines, and other medical information, to determine incentive goal programs provided by one or more governmental and/or private organizations and generating patient registry entries in the patient registry database 490. The patient registry engine 410 operates to collect and compile for each patient, medical information from patient EMR sources 420 and other medical information sources 440. The patient registry engine 410 utilizes the medical knowledge and payment provider guideline source(s) 430 to assist with the ingestion and processing of this medical information for the patient as well as specify the requirements for various incentive goals. The collected and complied medical information for the patient is stored in one or more electronic health records (EHRs) in the patient registry database 490. The requirements of various incentive goals of one or more incentive goal programs provided by one or more incentive goal program providers, e.g., payment providers, are stored in the incentive goals database 417. It should be appreciated that the incentive goals entries in the incentive goals database 417 may be provided by the medical knowledge and payment provider guideline source(s) 430, may be manually input by a subject matter expert or practitioner 460, or the like.

The patient's EMRs 425 are provided by one or more patient EMR sources 420 to the patient registry engine 410 via the information communication interfaces 411 while other medical information may be provided from other medical information sources 440 via the information communication interfaces 411. The information communication interfaces 411 provides one or more data communication interfaces through which patient data, medical information, and the like, may be obtained from various patient EMR data sources 420 and other medical information sources 440, as well as medical knowledge and payment provider guideline sources 430. Moreover, the interfaces 411 comprise interfaces for interfacing with a medical practitioner management system 450 to provide alerts/notification of goal progress, receive input and requests from the medical practitioner, and in general exchange communications and data between the patient registry engine 410 and the medical practitioner management system 450.

The medical practitioner management system(s) 450 represent the computing system resources, data storage, and communication resources associated with a medical practitioner 460. In the depicted example, the medical practitioner is shown as a single human being, however the medical practitioner 460 may in fact be a plurality of human beings providing medical services, may be a medical practice, a provider of medical services, such as a medical lab, a hospital, or any other individual or organization that provides medical services and may be eligible for enrollment in one or more medical services based incentive goal programs offered by one or more medical service incentive program providers. It should be appreciated that while a single medical practitioner management system 450 is shown in FIG. 4, the illustrative embodiments are not limited to such and may in fact operate to perform the operations of the illustrative embodiments with regard to incentive goal progress determinations, candidate patient identification, and communication with patients, for a plurality of medical practitioners and a plurality of medical practitioner management systems 450. In some illustrative embodiments, the operations described herein may be performed with regard to a pool of patients and a pool of medical practitioners, and thus, their associated medical practitioner management systems 450, such that the operations are performed across medical practitioner boundaries and not limited to patients associated with a particular medical practitioner.

The EMR data sources 420 may comprise various sources of electronic medical records including individual doctor medical practice systems, hospital computing systems, medical lab computing systems, personal patient devices for monitoring health of the patient, dietary information, and/or activity information of the patient, or any other source of medical data that represents a particular patient's current and historical medical condition. In some illustrative embodiments, the patient EMR sources 420 may include medical practitioner management systems 450 as well. The other medical information source(s) 440 represent other possible sources of medical information about a particular patient, e.g., gym records that may indicate patient body-fat ratios, which may supplement or augment the patient EMRs 425 from other more medical service oriented sources. That is, the patient EMR sources 420 are considered to represent traditional sources of medical information about patients such as hospital computing systems, doctor office computing systems, medical lab systems, and the like. The other medical information source(s) 440 represent non-traditional sources of medical information, such as gyms, alternative therapy service providers, and the like.

The medical knowledge and payment provider guideline sources 430 provide information to the patient registry engine 410 indicating general medical knowledge regarding various medical maladies from established medical knowledge bases, information regarding policies of various payment providers as specified in payment provider guidelines, and of particular importance to the mechanisms of the illustrative embodiments, incentive programs, and their associated incentive goals, provided by the particular individual payment providers, health insurance companies, government agencies and programs, and the like (referred to collectively herein as “incentive program providers”). This information may be used by the patient registry engine 410 to identify incentive goals, their conditions for meeting these incentive goals, corresponding monetary incentives receivable by qualifying for the incentive, and the like. The incentive goal information may be stored in incentive goal databases 417. Each incentive program provider may have their own separate incentive goals database 417 that comprises entries for the various incentive programs that they provide and the corresponding incentive goals associated with those programs.

The communication systems 470 represents one or more systems for sending and receiving communications with patient communication systems 480-484. These communication systems 470 may comprise systems for sending/receiving communications of various communication modes including telephone communications, electronic mail communications, instant messaging and/or text messaging communications, or the like. The communication systems 470 may be provided by the same provider as the patient registry engine 410, and in some cases may be integrated with the patient registry engine 410, or may be provided by third party providers, such as vendors for the providing of the patient registry engine 410.

The patient communication systems 480-484 may be any type of communication equipment used by a patient that is capable of receiving/sending communications. Such systems 480-484 may comprise wired/wireless telephones, smart phones, stationary or portable computing systems, tablet computing systems, or the like. It should be appreciated that the communications between the communication systems 470 and the patient communication systems 480-484, as well as any communication between the patient registry engine 410 and the other elements shown in FIG. 4, may be facilitated by one or more wired or wireless communication systems of an analog or digital nature. In some illustrative embodiments, such one or more communication systems comprise one or more data communication networks, such as the Internet.

The communications systems 470 may utilize automated mechanisms for automatically sending communications to patient communication systems 480-484 using pre-defined templates or scripts which may or may not be customized to the particular patient being communicated with based on the information retrieved from the patient registry database 490 for that patient. The communication systems 470 may further include systems that facilitate human interaction as part of the communication, e.g., human operators, assessors, and the like, that communicate with the patients via the patient communication systems 480-484, such as via instant messaging or chat sessions, telephone communication, multi-media communications comprising video, audio, and/or text, or the like.

The communication systems 470 may further receive communications back from the patient communication systems 480-484 including voice response, user interface manipulation by the patient, response text messages, or any other responsive communication. These responsive communications may be used to update patient registry database information 490 with regard to success/failure of communication attempts, such as for purposes of selecting patients for contacting to assist in helping practitioners achieve their incentive goals as discussed hereafter. Moreover, in some cases, the responsive communications themselves may represent a compliance action/event that may be used to update the progress of a practitioner towards an incentive goal.

As shown in FIG. 4, the patient registry engine 410 comprises, in addition to the information communication interfaces 411 discussed above, an incentive goal progress engine 412, a patient evaluation engine 413, an alert/notification engine 414, a communication systems interface 416, and one or more incentive goal database 417. The incentive goal progress engine 412 operates in conjunction with the patient evaluation engine 413 and the incentive goals databases 417 to identify, for each incentive goal specified in the incentive goals database 417, a particular medical practitioner's progress towards achieving the incentive goal. Thus, for example, the patients associated with the medical practitioner in the patient registry database 490 are identified. Of the patients associated with the medical practitioner, those that qualify for satisfying conditions of the incentive program are identified, e.g., are associated with the provider of the incentive program and meet minimum requirements for inclusion in the incentive program or a particular incentive goal within the incentive program. That is, if an incentive program is associated with a particular government organization (e.g., United States military), government program (e.g., Medicare/Medicaid), or private provider (e.g., private health insurance provider), then those patients associated with the particular government organization, government program, or private provider (again, these are collectively referred to herein as “incentive program providers”) are first identified by the patient evaluation engine 413, e.g., if the incentive program is offered by ABC Health Insurance Company, then all of the medical practitioner's patients that use ABC Health Insurance Company as their health insurance provider will be identified.

Of those patients meeting the requirements of the incentive program, those that meet the requirements of the incentive program's particular incentive goal are identified based on their patient information in the patient registry database 490. Such identification may be based on identifying patients with certain medical maladies, diagnoses, treatments, demographic characteristics, or any other characteristics of the patient that may be specified as a condition of the incentive goal. For example, an incentive goal, stored in the incentive goal database 417 for the incentive program provider ABC Health Insurance, may specify that at least 80% of the practitioner's type 2 diabetic diagnosed patients must have received a foot examination in the calendar year. Thus, the criteria for identifying patients that meet the criteria of the incentive goal comprises “type 2 diabetic” diagnosed patients. Hence, the patient evaluation engine 413, in concert with the incentive goal progress engine 412 which retrieves the incentive goals from the incentive goals databases 417, may identify the ABC Health Insurance patients that are associated with the medical practitioner 460, and then identify within this subset of patients which are type 2 diabetic diagnosed patients to generate a sub-subset.

The identification of patients whose patient information in the patient registry database 490 meet the criteria of an incentive program's incentive goals may be based on any suitable identifiers of these criteria. In some illustrative embodiments, these criteria may be specified as medical codes used to identify various medical maladies, diagnoses, medications, treatments, or the like. These medical codes may be established by the incentive program providers and may be specified in the information received from the medical knowledge and payment provider guideline sources 430. Thus, for example, a code of “L5000” may be assigned by the incentive program provider for patients diagnosed with type 2 diabetes in which case the criteria for the incentive program's incentive goal may specify patients having a “L5000” diagnosis, in which case the patient information for the patients may be analyzed to determine if the patient has this medical code as part of a previous diagnosis of the patient.

It should be appreciated that the illustrative embodiments are not limited to use of medical codes. To the contrary, key terms, key phrases, natural language content, and the like may be used in addition to, or in replacement of, medical codes as criteria for indicating when a patient satisfies requirements of an incentive program and/or incentive program's incentive goals. In such cases, natural language processing of the patient information retrieved from the patient registry database 490 may be performed by the patient evaluation engine 413 to determine if the patient's information comprises the required key terms, key phrases, natural language content, or the like.

Moreover, the evaluation of the patient information by the patient evaluation engine 413 may be temporally restricted as well. For example, instances of medical codes, key terms, key phrases, natural language content, or the like, for satisfying criteria of an incentive program or incentive program's incentive goals may be restricted to those that were added to the patient information within a specified time frame of the current time, e.g., within the last 3 years, for example. Any time frame that is suitable to the particular implementation may be utilized and different time frames may be used for different incentive programs and/or incentive goals. These time frames may be specified by the incentive program provider as part of the information receive from source 430, for example.

Having identified the patients meeting the minimum criteria of the incentive program and incentive goal by way of the evaluation performed by the patient evaluation engine 413, the incentive goal progress engine 412 works with the patient evaluation engine 413 to determine which of these patients have already met the incentive goal's requirements with regard to the compliance action/event. The compliance action/event is an action or event that must be performed by the patient and/or medical practitioner to satisfy the requirements of the incentive goal. For example, if the incentive goal specifies patients must have received an annual foot examination, then the compliance action/event is the annual foot examination having been completed by the patient/medical practitioner. This information may again be specified by medical codes, natural language text, or the like, included in the patient information of the patient registry database 490. Thus, again, the patient evaluation engine 413 may analyze the patient information for the patients identified as meeting the minimum criteria of the incentive program and incentive goal to determine if the corresponding medical code or natural language text, key term, key phrase, or the like, is present in the patient information indicating that, within the time period of the incentive goal's applicability, the patient received the specified treatment. For example, using the running example above, patients having ABC Health Insurance and previously diagnosed within the last 3 years as a type 2 diabetic have their patient information analyzed to determine if a corresponding medical code or natural language text, key term, key phrase, or the like, is present in the patient information indicating that within the calendar year (annual), the patient received the specified treatment of an annual foot exam.

A statistical measure of the patients that have met the criteria of the incentive program is calculated based on the results of the evaluations of the patients to determine the progress of the medical practitioner towards achieving the specified incentive goal. For example, of the patients qualifying for the incentive goal a total number of those that have met the requirements of the incentive goal is calculated and compared to the total number of patients qualifying to generate a ratio. This ratio may be compared to a threshold requirement for the medical practitioner to have met the incentive goal. For example, in the running example, those type 2 diabetic patients having ABC Health Insurance that have received their annual foot exam are totaled and compared to the total number of type 2 diabetic patients having ABC Health Insurance to get a percentage value indicative of the percentage of type 2 diabetic patients covered by ABC Health Insurance that the particular medical practitioner has provided medical services of an annual foot exam (e.g., 70% of these patients received their annual foot exam). This percentage may be compared to a percentage threshold, e.g., at least 80%, to determine if the medical practitioner 460 has achieved the incentive goal, and if not, by how much the medical practitioner 460 is currently failing to achieve the incentive goal. This determination of how much the medical practitioner is failing to achieve the incentive goal may be used as a basis for determining what actions the medical practitioner should perform in order to achieve the incentive goal, e.g., 10% more type 2 diabetic patients need to come into the medical office and receive their annual foot exam (10 patients if the total number of type 2 diabetic patients having ABC Health Insurance is 100 patients).

This information may be presented to the medical practitioner by the alert/notification engine 414 via the interfaces 411 and the medical practitioner management system 450. For example, a notification may be sent to the medical practitioner management system 450 indicating the progress that the medical practitioner 460 has made on each of a plurality of incentive goals for each of a plurality of incentive programs provided by one or more incentive program providers. These may be presented in an alphanumeric message, a graphical representation, such as a bar graph, progress bar representation, or the like, or any other suitable representation of progress depending upon the desired implementation.

The incentive goal progress engine 412 may further operate, in response to determining that the medical practitioner 460 has not yet reached the requirements for achieving an incentive goal, to identify patients listed in the patient registry database 490 that meet the criteria of the incentive goal and which may be contacted to solicit the patient engaging in a compliance action/event. That is, the incentive goal progress engine 412 may analyze the patient information in the patient registry database 490 to identify, for the practitioner 460, the most likely patients that will perform the required compliance action/event if engaged with. These patients may be selected from the patients associated with the medical practitioner 460 or may be patients associated with a plurality of medical practitioners. This analysis targets the patients that are most likely to help achieve the incentive goal as determined from evaluation of the patients' characteristics as qualifying for the particular incentive goal, e.g., type 2 diabetic patient, the patient's previous historical responses to such engagements, as well as historical information specifically directed to the particular action required, e.g. getting a wellness check done. This evaluation may take into consideration historical information as to the responsiveness in general of patient's to such engagements such that more patients that are required to achieve the incentive goal may be communicated with knowing that not all of these patients will respond with a compliance action/event that will further the practitioner's progress towards the incentive goal.

For example, having previously identified the patients associated with the medical practitioner 460 that meet the requirements of the incentive program and incentive goal with regard to characteristics of the patient specified in the patient information, e.g., medical codes, demographic information, natural language text, and the like, as discussed above when determining the progress of the medical practitioner towards achieving the goal, the subset of these patients that have not performed the compliance action/event for the incentive goal may be identified as discussed above. Of these patients, the historical information regarding responsiveness to communications may be analyzed to identify those patients that are most likely the ones that will respond to a communication regarding the compliance activity/event. For example, the mechanisms in commonly assigned and co-pending U.S. patent application Ser. No. 15/012,922 (Attorney Docket No. SVL920150141US1) may be used to analyze patient information and determine the responsiveness of patients to various types of communications or communication modes. This information may be monitored by monitoring responses received directly in relation to communications sent and/or by monitoring occurrences of compliance actions/events logged by medical practitioner management systems and/or sources 420, 440 of patient information. For example, a determination may be made as to whether a compliance action/event occurs within a specified time period of a communication and if so, then it may be determined that the compliance action/event is in response to the communication. In such a case, this information may be logged in a communication history associated with the patient information indicating the communication mode and that the patient is responsive to that communication mode. Moreover, particular preferences, consents, and the like may be specified in the patient information to identify modes of communication preferred by the particular patient.

The responsiveness of patients may be measured by looking at the histories of communications and identifying a ranking of patients with regard to each other based on relative responsiveness to communications. A number of patients from the ranked listing may be selected based on the measure by which the medical practitioner is not achieving the incentive goal. As noted above, in some cases, the number of patients selected may be in excess of the number needed to achieve the incentive goal based on historical analysis of responsiveness across all patients.

Once identified, human initiated or automated communications may be sent to the identified patients via the communication systems interface 416 to solicit the patients engaging in a compliance action/event. Such communications may be based on a determination of the best mode of communications and/or sequence of modes of communication to be sent to the particular patient as described in commonly assigned and co-pending U.S. patent application Ser. No. 15/012,922 (Attorney Docket No. SVL920150141US1), as discussed above. The mode(s) of communication used to communicate with the patient may be based on the patient registry information indicating preferences of the patient, consents provided by the patient, historical analysis of the patient's responsiveness, or a group of patients having similar characteristics, e.g., a patient cohort, and other factors for determining the best mode(s) of communication for maximizing the likelihood of the patient performing a compliance action/event. Moreover, based on the selection of the mode(s) of communication to be used, automated mechanisms may automatically sent such communications, possibly in accordance with a determined sequencing of the communications, using pre-defined templates of scripts which are customized to the particular patient. The system may also monitor for a subsequent compliance action/event being performed by the patient.

Based on the determined mode of communication, a request is sent to the communication systems 470 to send the corresponding communications to the patient communication systems 480-484 and corresponding records in the communication history of the patient information are updated to indicate that the patient was contacted with regard to the particular incentive goal. This communication information may be sued by the incentive goal progress engine 412 and communication systems interface 416 when selecting patients to contact and what communication modes to use to contact those patients. For example, this information may be used to facilitate managing repeated communications to the same patient regarding the same incentive goal, e.g., avoiding multiple communications of the same communication mode to the same patient regarding the same compliance action to achieve the same incentive goal. This record keeping in the communication history of the patient information may indicate the type of communication mode used, the timestamp associated with the communication, and any response from the patient that may have been received, among other information if desirable for the particular implementation.

Communications sent to patient communication system 480 may use contact information specified in the patient information of the patient registry database 490. Moreover, the communication systems 470 may return responses to these communications returned by the patient communication systems 480-484. The incentive goal progress engine 412 may monitor these responses and update the corresponding patient information in the patient registry database 490 and update progress information for achieving the incentive goals in the case where the response itself is a compliance action/event.

The monitoring of the practitioner's advancement towards the incentive goal by the incentive goal progress engine 412 may be periodically or continuously monitored such that additional communications, such as additional communications in accordance with a determined sequence, may be sent to the same or additional patients. For example, if the practitioner's advancement to towards the incentive goal is still wanting after an initial operation to contact patients to assist with achieving the incentive goal, then a subsequent update to the patients that may be likely to assist the practitioner in achieving their incentive goal may be performed and the process above repeated. In updating the set of patients to be contacted, patients that responded to the previous communications by performing a compliance action/event will be naturally eliminated from the set of patients to be contacted.

Patients that did not respond to the previous communications by performing a compliance action/event may be kept in the set of patients to be contacted or may be removed from the set, depending on the desired implementation. In some embodiments, where these non-responsive patients are maintained in the set of patients to be contacted, the set of patients may be expanded to include additional patients in the patient registry that meet the requirements for inclusion in the set of patients, but that were not previously selected for inclusion in the set of patients. In such embodiments, for those patients that are previous non-responsive patients, the communication mode for contacting these previous non-responsive patients may be updated to use a different communication mode than previously used.

It should be appreciated that this functionality for assisting the practitioner in achieving their incentive goals may be performed across many different incentive programs and incentive goals defined in the incentive goals databases 417 for the incentive program providers. Thus, for example, a practitioner 460 may be an approved provider of medical services for a plurality of different health insurance companies, each of which may have their own incentive programs established in their own incentive goals databases 417. The incentive goal progress engine 412 may monitor the practitioner's progress towards achieving each of these incentive programs and may identify patients, by their patient information from the patient registry database 490, that qualify for assisting the practitioner 460 in achieving these various incentive program goals. This may require taking into account the organizations with which the patient is associated, e.g., which health insurance company the patient uses to pay for health services. Moreover, this may involve, in some illustrative embodiments, determining which incentive program goals the practitioner 460 is closest to achieving and focusing the operation of the incentive goal progress engine 412 on those goals rather than all of the goals of the many different incentive programs of the many different incentive program providers. For example, the incentive goal progress engine 412 may perform its operations only for those incentive goals that the practitioner 460 is within a pre-defined range of the goal, e.g., only the goals which the practitioner only needs 30% or less additional participation from patients may be selected for use in performing the operations of the present invention.

In another illustrative embodiment, the mechanisms may be employed across a pool of practitioners 460 and a pool of patients registered in the patient registry database 490, so that patients that need certain medical care can be paired with practitioners 460 that need to provide that medical care to meet desired incentive goals. That is, in some illustrative embodiments, patients are directed to particular practitioners that need those patients based on the needs of that practitioner to achieve incentive goals regardless of whether that patient has been associated with the practitioner in the past or not. Thus, rather than limiting the analysis of patient information to identify candidate patients to contact for achieving incentive goals to the patients associated with the practitioner, the analysis is expanded to all patients of a particular pool, e.g., all patients within a geographic region of the practitioner and that meet the requirements of the incentive goal, regardless of whether they are actually associated with the practitioner or not. Various levels of granularity may be applied to define the pool of the patients considered for such analysis including, but not limited to, identify patients that are associated with a same network of medical practices, a same health insurance company or payment provider, employed by the same or affiliated employers, or the like.

The main concept in these illustrative embodiments is that the analysis is not limited to only existing patients of the practitioner. However, preference may be provided to existing patients of the practitioner such that these existing patients may be selected first in a priority manner over other patients that are not existing patients when determining the set of patients to contact. In subsequent iterations, where the patients to contact may need to be expanded, additional priority preference may be provided to other patients that are not existing patients of the practitioner but have other desirable characteristics, such as geographical location of the patient relative to the practitioner, for example.

Thus, the illustrative embodiments provide functionality for assisting a medical practitioner 460 in achieving incentive goals established by an incentive goal provider and pre-defined in an incentive goals database 417. The incentive goal progress engine 412, in concert with the patient evaluation engine 413, determines the practitioner's progress towards the incentive goal as well as the actions that are required for the practitioner 460 to achieve the incentive goal, e.g., amount of additional participation of various incentive goals that the practitioner must obtain. This information may be reported to the practitioner in alerts or notifications sent to a computing system 450 associated with the practitioner 460, and may be provided in an alphanumeric, graphical, or multi-media manner, via an alert/notification engine 414. Moreover, the incentive goal progress engine 412, in concert with the patient evaluation engine 413, identifies patients that can assist the practitioner 460 in achieving the incentive goal and, with the assistance of the communication systems interface 416, initiates communications for contacting these patients to solicit a compliance action/event from the patients which will advance the practitioner's progress towards achieving the incentive goal. The particular communication modes to utilize as well as the contact information for the patients may be obtained from analysis of the patient information retrieved from the patient registry database, including communication histories, consents, preferences, and the like. Such mechanisms may operate across a pool of practitioners 460 and a pool of patients and may monitor multiple incentive goals provided by the same or a plurality of different incentive goal program providers, as specified in the incentive goals databases 417.

It should be noted that the operation of the illustrative embodiments for determining progress of a medical practitioner towards achieving incentive goals may be initiated in response to any of a number of triggering events. These triggering events may include, but are not limited to, a periodic schedule of triggers for monitoring the progress of the practitioner, an elapsed time since a last evaluation of the progress of the medical practitioner, a current time being within a predetermined time period of the evaluation time period of an incentive goal or incentive program, e.g., programs may be evaluated on a monthly, quarterly, annual basis, or the like, a human operator requesting the determination of progress, e.g., the medical practitioner sending a request to the patient registry engine 410, or the like.

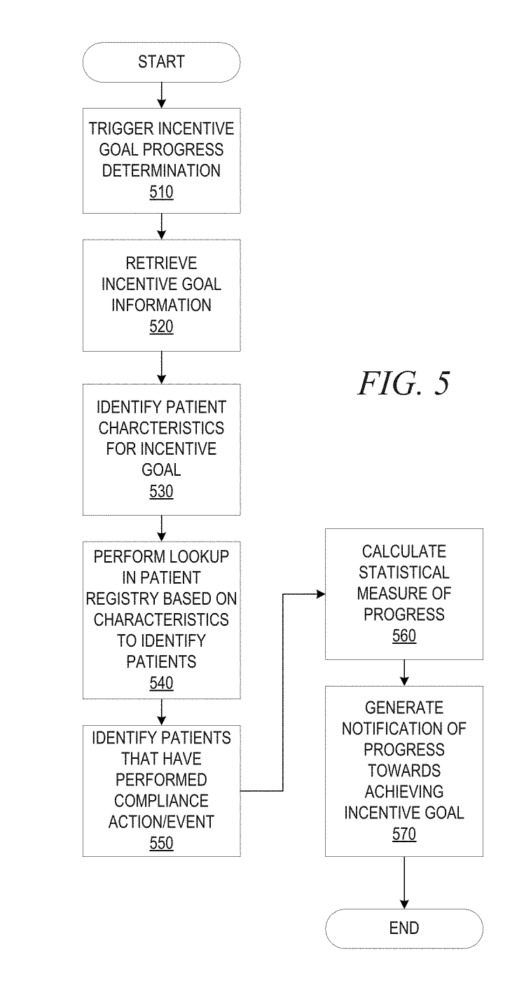

FIG. 5 is a flowchart outlining an example operation for identifying a practitioner's progress towards achieving an incentive goal in accordance with one illustrative embodiment. For ease of explanation, FIG. 5 focuses on a single medical practitioner and a single incentive goal. However, it should be appreciated that the mechanisms of the illustrative embodiments may be applied across a plurality of medical practitioners, a plurality of incentive goals, a plurality of incentive programs, and a plurality of incentive program providers without departing from the spirit and scope of the present invention.

As shown in FIG. 5, the operation starts by the triggering of the incentive goal progress determination in accordance with a triggering event (step 510) and retrieval of incentive goal information from the incentive goals database corresponding to the incentive program provider (step 520). The incentive goal information is analyzed to identify the requisite characteristics of patients that fall within the incentive goal requirements (step 530). It should be appreciated that these are characteristics of the patient and not whether or not the patient has performed a compliance action/event.

A lookup operation is performed in the patient registry database to identify patients having characteristics that meet the requisite characteristics of the incentive goal (step 540). These patients may be specific to the particular medical practitioner for which the evaluation is being performed. The patient information for these patients meeting the requisite characteristics is analyzed to determine if a compliance action/event has been recorded in the patient information within a specified applicable time period associated with the incentive goal (step 550), e.g., if the incentive goal is evaluated on an annual basis then the compliance action/event must have been recorded within the present calendar year. For those patients that have a qualifying compliance action/event a statistical measure is calculated to determine a progress of the practitioner towards the incentive goal (step 560). A notification indicating the progress of the practitioner towards the incentive goal is generated and output (step 570). The operation then terminates.

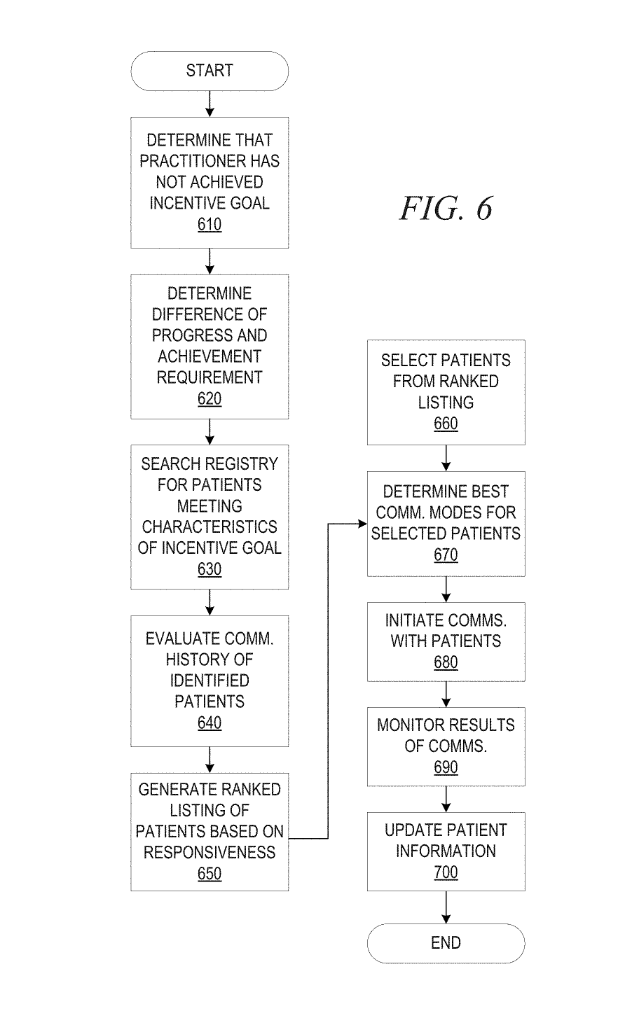

FIG. 6 is a flowchart outlining an example operation for performing operations to select patients to contact and initiate communications with the selected patients based on a progress of a practitioner towards an incentive goal in accordance with one illustrative embodiment. As shown in FIG. 6, the operation is triggered by determining that the practitioner has not satisfied the achievement requirement of an incentive goal (step 610). A measure of difference between the progress achieved by the practitioner and the achievement requirement is calculated (step 620). The patient registry is searched for patients that meet the patient characteristic requirements of the incentive goal and which have not already performed the compliance action/event within the applicable period of time of the incentive goal (step 630). It should be appreciated that this search may be limited to the particular patients associated with the practitioner or may be more open to patients across practitioners, depending on the desired implementation.

For those patients identified by the search, the communication history of the patient information for those patients is evaluated (step 640) and a ranked listing of patients based on their responsiveness to communications is generated (step 650). A number of patients in the ranked listing are selected, in accordance with rank, for initiating communications based on the determined difference between the progress achieved by the practitioner and the achievement requirement, possibly taking into consideration an additional factor based on historical analysis of patients as a whole and their general responsiveness (step 660). It should be appreciated that in subsequent iterations, the selection of patients from the ranked listing may further take into consideration whether the patient has been previously communicated with regarding this incentive goal or not, the timing of such a previously communication, and the like, so as to avoid repeated communications to the same patient that may be perceived by the patient to be annoying or harassment.

For those selected patients, best communication modes for communicating with the patient are determined based on their personal patient information, preferences specified, consents provided, previous responsiveness to communications, previous modes of communication used to contact the patient regarding the incentive goal, and the like (step 670). Communications are then initiated with the patients based on their individual best communication modes (step 680) and results of the communications are monitored (step 690). The patient information for the patients is updated to reflect the communications sent and any results of those communications (step 700). The operation then terminates.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

1-10. (canceled)

11. A computer program product comprising a computer readable storage medium having a computer readable program stored therein, wherein the computer readable program, when executed in a data processing system, causes the data processing system to:
generate a patient registry comprising a plurality of patient registry records, each patient registry record being associated with a corresponding patient and comprising personal and medical information about the corresponding patient;
evaluate a registry of incentive goals for a medical practitioner based on the patient registry to determine an incentive goal whose criteria the medical practitioner has not yet met;
determine an action to be performed by one or more patients to meet the criteria of the incentive goal;
analyze the patient registry to identify a set of patients to perform the action; and
generate an output identifying the set of patients.

12. The computer program product of claim 11, wherein the computer readable program further causes the data processing system to:
send, via a communication system, a communication to each patient in the set of patients soliciting performance of the action by the patient.

13. The computer program product of claim 11, wherein the registry of incentive goals comprises incentive goals for monetary compensation provided by one of a governmental health care program organization or a private health care payment provider organization.

14. The computer program product of claim 11, wherein the computer readable program further causes the data processing system to evaluate the registry of incentive goals for a medical practitioner periodically over a predetermined period of time of applicability of the incentive goals.

15. The computer program product of claim 11, wherein the set of patients comprises patients whose corresponding patient records in the patient registry indicate that the patient has not performed the action that assists the medical practitioner in meeting the criteria of the incentive goal.

16. The computer program product of claim 15, wherein the computer readable program further causes the data processing system to analyze the patient registry to identify a set of patients to perform the action in response to being contacted at least by:
calculating, for each patient in the patient registry whose corresponding patient record indicates that the patient has not performed the action, a probability value indicating a probability that the patient will perform the action in response to a communication being sent to the patient; and
identifying the set of patients by selecting patients based on their corresponding calculated probability values.

17. The computer program product of claim 15, wherein the computer readable program further causes the data processing system to:
send, by a communication system, communications to communication devices associated with patients in the set of patients;
monitor responsiveness of the patients in the set of patients to the communications; and
expand the set of patients in response to one or more of the patients in the set of patients not responding to the communications.

18. The computer program product of claim 15, wherein the set of patients is selected from patients whose patient records indicate that the patient is an existing patient of the medical practitioner.

19. The computer program product of claim 15, wherein the set of patients is selected from patients whose patient records indicate that the patient is within a predetermined specified pool of patients that comprise patients that are not existing patients of the medical practitioner.

20. An apparatus comprising:
at least one processor; and
at least one memory coupled to the at least one processor, wherein the at least one memory comprises instructions which, when executed by the at least one processor, causes the at least one processor to:
generate a patient registry comprising a plurality of patient registry records, each patient registry record being associated with a corresponding patient and comprising personal and medical information about the corresponding patient;
evaluate a registry of incentive goals for a medical practitioner based on the patient registry to determine an incentive goal whose criteria the medical practitioner has not yet met;
determine an action to be performed by one or more patients to meet the criteria of the incentive goal;
analyze the patient registry to identify a set of patients to perform the action; and
generate an output identifying the set of patients.
